(19) United States
(12) Patent Application Publication
(10) Pub. No.: US 2014/0032639 A1
(43) Pub. Date: Jan. 30, 2014

(54) SYSTEM AND METHOD FOR UPDATING A NETWORK CLIENT FROM STREAMING EVENT DATA

(71) Applicants: Daren Trousdell, Palm Beach Gardens, FL (US); Richard Reed, Port St Lucie, FL (US); Roger Dalal, Palm City, FL (US)

(72) Inventors: Daren Trousdell, Palm Beach Gardens, FL (US); Richard Reed, Port St Lucie, FL (US); Roger Dalal, Palm City, FL (US)

(73) Assignee: ONEUP GAMES LLC, Palm Beach Gardens, FL (US)

(21) Appl. No.: 13/557,692

(22) Filed: Jul. 25, 2012

(51) Int. Cl. G06F 15/16

(52) U.S. Cl. 709/203

(57) ABSTRACT

A method of updating a network client with event data involves the network client registering with a computer server a unique association between a network user and a data object maintained by the computer server. The data object identifies a plurality of pre-determined events. The computer server is configured to receive event data and to update the data object in accordance with an occurrence of one of the associated pre-determined events in the received event data. The network client receives from the computer server a network client update indicating the occurrence of the one pre-determined event in the received event data. The network client then notifies the network user of the occurrence of the indicated one pre-determined event.

### FIELD

This patent application relates to a system and method for updating a network client via a computer network. In particular, this patent application relates to a data processing system for updating network clients with event data.

### BACKGROUND

Sports-based games incorporate event data from real-world sporting events into conventional board-based or online games. Yamaguchi (U.S. Pat. No. 7,128,320) describes a pre-printed baseball-based bingo game sheet that includes a matrix of squares each associated with a particular inning or special event designation (e.g. curve ball, single hit, home run, walk, stealing home). Game participants watch a baseball game, and mark the game sheet squares based on the occurrence of plays in the game. A computer receives official data regarding the plays in the baseball game, and determines whether a game sheet presented by a game participant is a winning game sheet.

Hill (U.S. Pat. No. 8,152,641) expands upon this idea by using capture devices to acquire sensory and/or gameplay data from a live card game, and a computer server to present the acquired data as part of an online card game. Remote online players use respective client terminals to connect to the computer server and thereby participate in the online game as if the online players were actually present in the live card game. The acquired data may be streamed to the client terminals in real-time, or may be stored in a database for presentation to the client terminals at a later time.

Mazursky (US 2012/0129610) describes integrating live statistical data from a live sports game into an online multi-player fantasy game. A computer server receives real-time statistical data corresponding to real-life statistical events (e.g. first down) in a sports game (e.g. football, basketball, baseball, hockey), and saves the statistical events in a database if the statistical data is associated with one of the fantasy games hosted by the computer server. Online players use client terminals to select one of the hosted fantasy games, and to transmit wager inputs (e.g. a wager on a first down) to the computer server. When real-time statistical events of a fantasy game are detected, the computer server assigns virtual monetary bonuses or penalties to the online players based on the players' respective wager inputs and the statistical events, and transmits the statistical events to the players' client terminals to thereby update the displays of the client terminals.

### SUMMARY

By way of overview, in a first aspect this disclosure relates to a method of updating network clients with event data. The first aspect of this disclosure also relates to an event data processing system, and a computer-readable medium having computer processing instructions stored thereon that implement a computer server and the method of updating network clients.

The method of the first aspect of this disclosure involves a computer server updating an event database with at least one event record in accordance with a correspondence between at least one event definition and event data received at the computer server. Each event record identifies an occurrence of an event in the event data. The computer server updates at least one data object from the at least one event record. Each data object is uniquely associated with a respective network user and identifies a plurality of pre-determined events. The step of updating a data object identifies an occurrence of at least one of the pre-determined events.

In accordance with the data object updating, the computer server provides a network client associated with one of the network users a network client update that indicates the occurrence of the associated at least one pre-determined event. The network client is configured to notify the associated network user of the occurrence of the indicated at least one pre-determined event.

The event data processing system of the first aspect of this disclosure includes an event definition database, an event database, and a computer server. The event definition database comprises a plurality of event definitions. The event database comprises a plurality of event records. The computer server is configured to (i) receive event data, and (ii) incorporate into the event database a new event record in real-time in accordance with a correspondence between one of the event definitions and the received event data, and (iii) update at least one data object from the new event record.

The new event record identifies an occurrence of an event in the event data. Each data object is uniquely associated with a respective network user and identifies a plurality of pre-determined events. Each updated data object identifies an occurrence of at least one of the pre-determined events. The computer server is also configured to (iv), in accordance with the data object update, provide a network client (associated with one of the network users) a network client update indicating the occurrence of the associated at least one pre-determined events.

In one implementation, the method of updating network clients involves the computer server generating the pre-determined events from a probability of occurrence thereof, and assigning the generated pre-determined events to one of the data objects. The computer server may also associate a virtual game with a portion of the event data, and may update the data object of the network client by associating the data object with a virtual game selected by the network user.

The network client may use the computer server to register an association between the network client and the data object of the one network user, and the computer server may provide the network client update by pushing the network client update to the registered network client upon the occurrence of the indicated at least one pre-determined event.

The computer server may associate a plurality of the data objects with a common virtual game, and the computer server may update the at least one data object by using the at least one event record to locate the common virtual game and, in accordance with the at least one pre-determined event, updating the at least one data objects of the located common virtual game. The computer server may provide the network client update by maintaining a set of rules, and notifying the network users associated with the data objects of the common virtual game of one of the data objects of the common virtual game satisfying one of the rules of the set of rules.

In a second aspect, this disclosure relates to a method of updating a network client with event data. The second aspect of this disclosure also relates to a communications device, and a computer-readable medium having computer processing instructions stored thereon that implement the network client and the method of updating a network client.

The method of the second aspect of this disclosure involves a network client registering with a computer server a unique association between a network user and a data object maintained by the computer server. The data object identifies a plurality of pre-determined events. The computer server is configured to receive event data and to update the data object in accordance with an occurrence of one of the associated pre-determined events in the received event data.

The network client receives from the computer server a network client update that indicates the occurrence of the one pre-determined event in the received event data. The network client then notifies the network user of the occurrence of the indicated one pre-determined event.

The communications device of the second aspect of this disclosure includes a display device, and a data processor. The data processor is configured to (i) register with a computer server a unique association between a network user and a data object maintained by the computer server. The data object identifies a plurality of pre-determined events. The computer server is configured to receive event data and to update the data object in accordance with an occurrence of one of the associated pre-determined events in the received event data.

The data processor is configured to (ii) receive from the computer server a network client update indicating the occurrence of the one pre-determined event in the received event data, and (iii) display on the display device a notification of the occurrence of the indicated one pre-determined event.

In one implementation, the computer server associates a virtual game with a portion of the event data, and the network client registers an association with the computer server by selecting one of the virtual games. The network client may receive the network client update from the computer server upon the occurrence of the indicated one pre-determined event.

### BRIEF DESCRIPTION OF THE DRAWINGS

The foregoing aspects of this disclosure will now be described, by way of example, with reference to the accompanying drawings, in which:

FIG. 1 is a block diagram that illustrates a communications network comprising the event data processing system and the communications device;

FIG. 2 is a schematic view of the communications device;

FIG. 3 is a schematic view of the event data processing system;

FIG. 4 is a flow chart that depicts, by way of overview, the network client updating method as implemented by the communications device;

FIG. 5 is a flow chart that depicts, by way of overview, the network client updating method as implemented by the event data processing system; and

FIGS. 6a and 6b together comprise a detailed message flow diagram that depicts a sample embodiment of the network client updating method.

### DETAILED DESCRIPTION

### 1. Communications Network—Overview

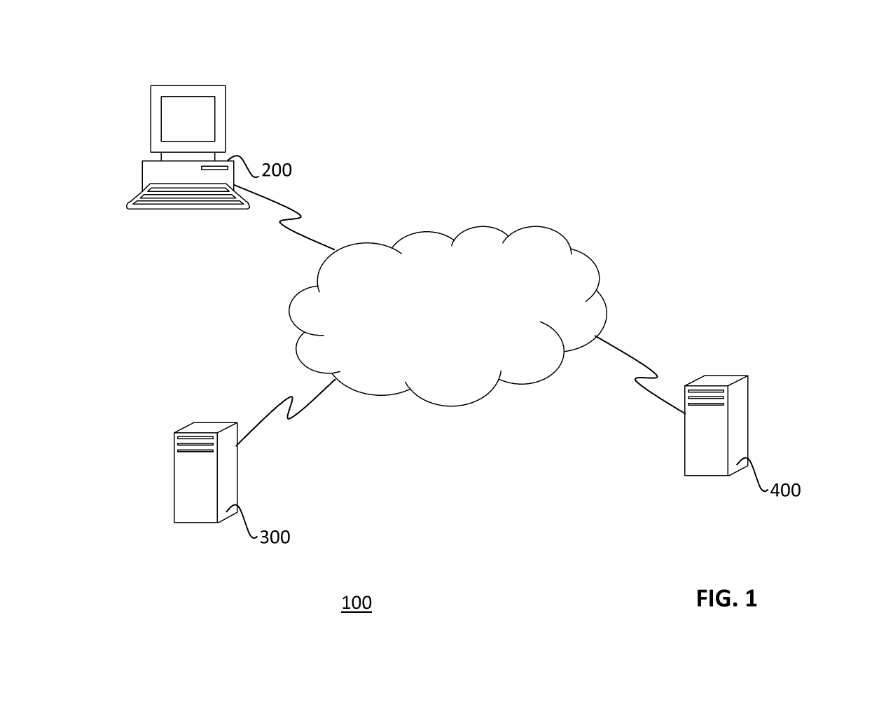

Referring to FIG. 1, there is shown a communications network, denoted generally by reference number 100, that includes a communications device 200, an event data processing system 300, and a real-time data source 400. Although the communications network 100 is shown comprising only a single communications device 200 and a single event data processing system 300, typically the communications network 100 is implemented as a wide area network, such as the Internet, and includes a plurality of the communications devices 200.

As will be discussed in further detail below, the real-time data source 400 provides the event data processing system 300 with streaming event data in real-time or substantially real-time. The event data streams specify events (e.g. Player A home run, Team B field goal, Team A free throw, Player B strike-out, Team A first down, Player A walk, Player B touch down, Player A fly ball, Team B interception, Player C basket) as they occur in respective live sports games, and the time/date of occurrence of each event.

The event data processing system 300 is configured to receive the streaming event data, to update data objects (each associated with a respective network user) in accordance with the occurrence of pre-determined events in the received event data, and to provide network clients (deployed on the communications devices 200) with network client updates that indicate the occurrence of the pre-determined events. Each communications device 200 includes a network client that is configured to notify the associated network user of the occurrence of the indicated pre-determined event.

In a preferred implementation, the event data processing system 300 hosts a plurality of online sports-based board games for the communications devices 200, and the real-time data source 400 provides the event data processing system 300 with streaming event data associated with live sports games. It should be understood, however, that the invention described herein is not limited to this particular implementation but can be implemented using event data associated with other activities.

### 2. Communications Device

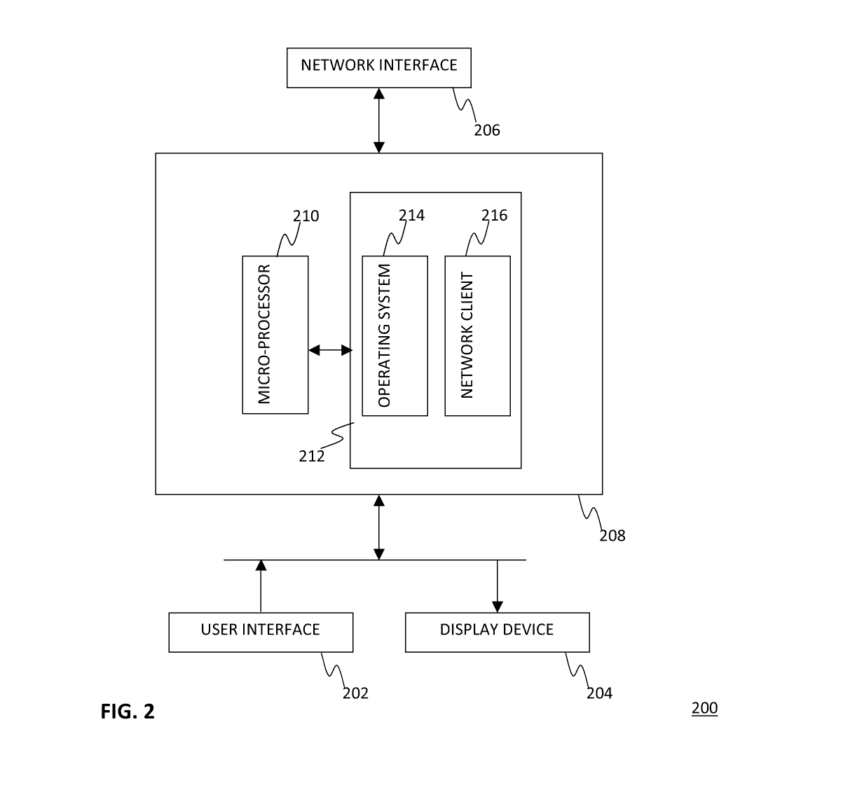

The communications device 200 is typically implemented as a wireless or wired communications device, such as a personal or tablet computer, a mobile phone, a smartphone or a personal digital assistant (PDA). As shown in FIG. 2, the communications device 200 includes a user interface/input device 202, a display device 204, a network interface 206, and a computer processing unit 208 that is coupled to the input device 202, the display device 204 and the network interface 206. Preferably, the input device 202, the display device 204, the network interface 206 and the computer processing unit 208 are integrated together within a common housing.

The input device 202 may be implemented as a keyboard, touchpad, and/or touchscreen and/or other input device suitable for allowing the user of the communications device 200 (hereinafter a “network user”) to input data and/or commands into the communications device 200. The display device 204 may comprise a liquid crystal display (LCD) panel, cathode ray tube (CRT) display, plasma display panel, and/or other output device suitable for displaying information to the (network) user of the communications device 200. The network interface 206 interfaces the communications device 200 with the event data processing system 300.

The computer processing unit 208 may include a microprocessor 210 and computer-readable medium 212. The computer-readable medium 212 may be provided as electronic computer memory (e.g. FLASH memory) that stores computer processing instructions. The computer processing instructions, when executed by the microprocessor 210, define an operating system 214 and one or more computer programs. The operating system 214 allows the communications device 200 to accept user input from the input device 202 and to control the display device 204. The operating system 214 also allows the communications device 200 to receive information/command messages from, and to transmit command messages to, the network interface 206.

One of the computer programs stored in the memory 212 may comprise a network client 216 that allows the operator of the communications device 200 to communicate with the event data processing system 300. The network client 216 is configured to register in the event data processing system 300 a unique association between a network user and a data object that is maintained by the event data processing system 300. The data object identifies a plurality of pre-determined events. As discussed above, the event data processing system 300 is configured to update the data object in accordance with an occurrence of one of the associated pre-determined events in the received event data.

As will be explained below, the network client 216 may receive from the event data processing system 300 a network client update that indicates that one of the pre-determined events associated with one of the network users has occurred in the received streaming event data. The network client 216 used by the network user is configured to display on the display device 204 a notification of the occurrence of the indicated one pre-determined event. Although the network client 216 is typically implemented as computer processing instructions, all or a portion of the functionality of the network client 216 may be implemented instead in electronics hardware.

### 3. Event Data Processing System

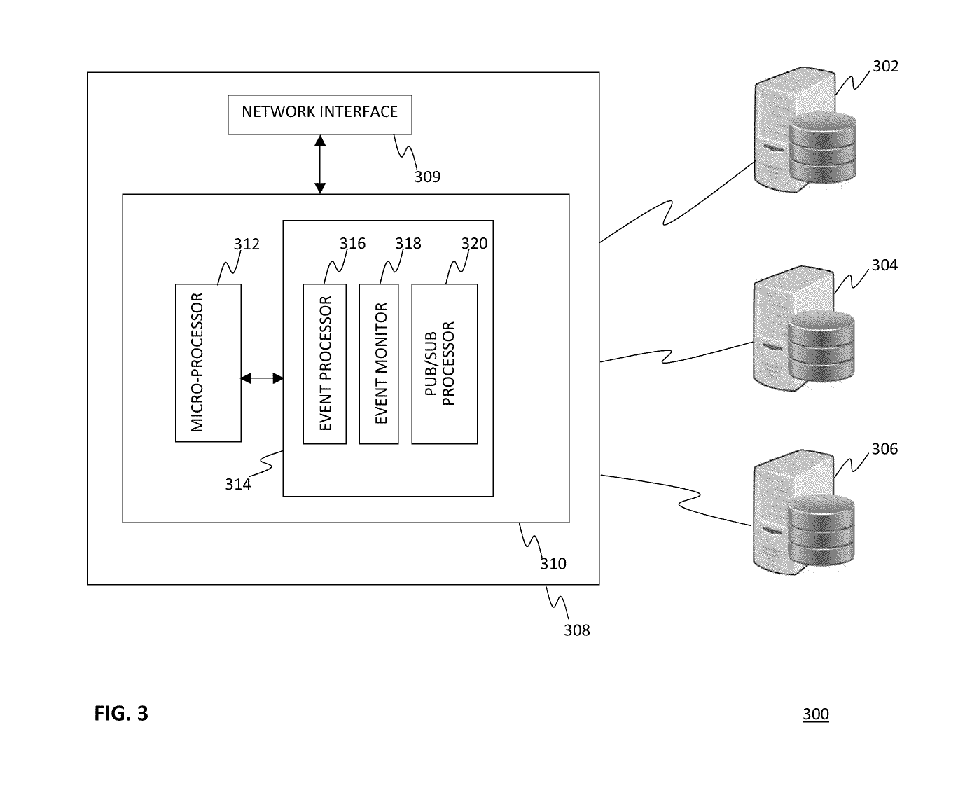

The event data processing system 300 may be implemented as one or more networked computer servers. As shown in FIG. 3, the event data processing system 300 includes an event definition database 302, an event database 304, a game object database 306, and a computer server 308.

The event definition database 302 includes a plurality of event definition records each specifying a respective pre-defined event. Each pre-defined event comprises an anticipated sports-related event (e.g. Player A home run, Team B field goal, Player B strike-out, Player A walk, Player A fly ball) that could occur in any of the baseball games monitored by the real-time data source 400.

The event database 304 includes a plurality of event records each identifying the occurrence of one of the real-time events in the streaming event data received by the event data processing system 300. The event database 304 typically does not include all the event data received from the real-time data source 400, but instead only comprises the event data that corresponds to any of the event definitions, as saved in the event definition database 302.

The game object database 306 includes a plurality of data objects. As will be explained in greater detail below, the data objects typically comprise parent data objects, and child data objects associated with the parent data objects. Each parent data object is associated with a respective virtual game. Each child data object is uniquely associated with a respective network user and identifies a plurality of pre-determined events. Preferably, the game object database 306 has a distributed memory architecture, and therefore comprises a plurality of computer processing units (not shown), and a plurality of private (non-shared) computer-readable media (not shown) each accessible by one of the computer processing units.

The computer server 308 includes a network interface 309, and a computer processing unit 310 that is coupled to the network interface 309. The network interface 309 allows the computer server 308 to communicate with the communications devices 200, the event definition database 302, the event database 304, and the game object database 306.

The computer processing unit 310 may include a microprocessor 312 and computer-readable medium 314. The computer-readable medium 314 may be provided as electronic computer memory (e.g. volatile memory, flash memory) or optical or magnetic memory (e.g. compact disc, hard disk) and saves a plurality of data objects. The computer-readable medium 314 stores computer processing instructions which, when executed by the computer processing unit 312, define an operating system (not shown) that controls the overall operation of the computer server 308. The computer processing instructions may also implement an event processor 316, an event monitor 318, and a publisher/subscriber processor 320.

The event processor 316 is configured to receive event data, and to incorporate into the event database 304 a new event record, in real-time or substantially real-time, in accordance with a correspondence between one of the event definitions (saved in the event definition database 302) and the received event data. The new event record identifies an occurrence of an event in the received event data.

The event monitor 318 is configured to monitor the event database 304 for the occurrence of new event records, and to update at least one of the data objects saved in the game object database 306 based on the new event record(s) saved in the event database 304. Accordingly, each updated data object identifies an occurrence of at least one of the pre-determined events. The event monitor 318 is also configured to notify the publisher/subscriber processor 320 of the updated data objects.

Preferably, the event monitor 318 also maintains a set of rules for each respective virtual game, and is configured to notify the network users associated with the data objects of each virtual game if a data object of one of the virtual games satisfies one or more rules of the set of rules for the associated virtual game.

The publisher/subscriber processor 320 is configured to provide the network clients 216 with network client updates indicating the occurrence of the pre-determined events. Preferably, the publisher/subscriber processor 320 pushes the network client update(s) to the network clients 216 in accordance with the data object updating, such that the network client 216 (of the associated network user's communications device 200) receives a network client update indicating the occurrence of one of the pre-determined event(s) specified in the data object of the associated network user.

### 4. Real-Time Data Processing—Overview

As discussed, the communications device 200 and the event data processing system 300 together implement a method of updating the network clients 216 with event data.

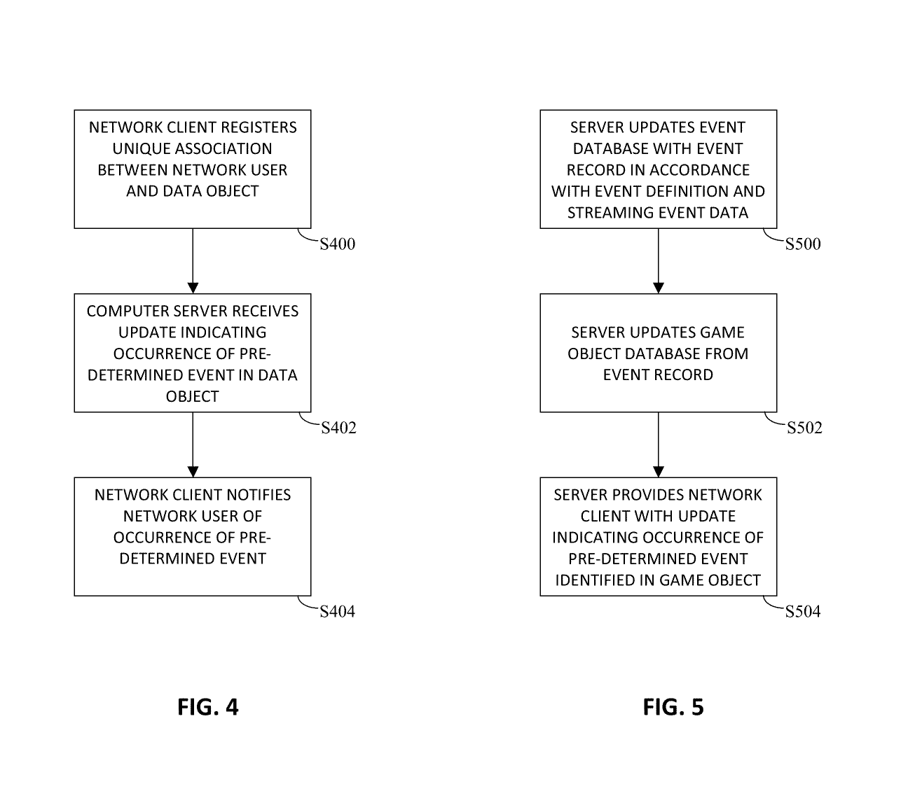

An embodiment of the network client updating method, as implemented by the network client 216, is depicted in FIG. 4. As shown therein, at the outset of the method, at step S400 the network client 216 registers with the computer server 308 a unique association between a network user and a data object that is maintained by the computer server 308. Each data object maintained by the computer server 308 identifies a plurality of pre-determined events. As discussed above, the computer server 308 is configured to receive streaming event data and to update the data objects in accordance with an occurrence of one of the associated pre-determined events in the received event data.

At step S402, the network client 216 receives from the computer server 308 a network client update that indicates the occurrence of the pre-determined event in the received event data. The network client then notifies the network user of the occurrence of the indicated pre-determined event, at step S404.

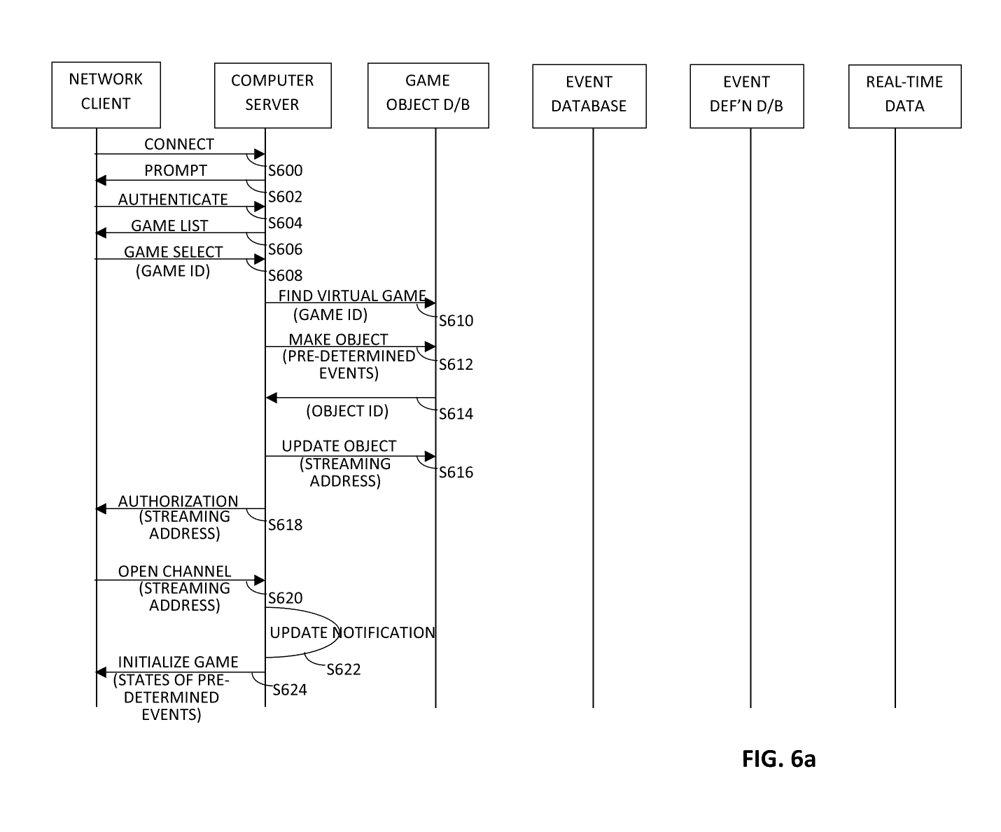

An embodiment of the network client updating method, as implemented by the event data processing system 300, is depicted in FIG. 5. As shown therein, at the outset of the method, at step S500 the computer server 308 updates the event database 304 in real-time, or substantially real-time, with at least one event record in accordance with a correspondence between at least one event definition stored in the event definition database 302, and streaming event data received at the computer server 308. Each event record in the event database 304 identifies the occurrence of an event in the streaming event data that the computer server 308 received from the real-time data source 400.

At step S502, the computer server 308 updates at least one data object in the game object database 306, from the event record(s) saved at step S500. Each data object in the game object database 306 is uniquely associated with a respective network user and identifies a plurality of pre-determined events. As a consequence of the step of updating data objects, the updated data object identifies an occurrence of at least one of the pre-determined events.

From the data object(s) updated at step S502, the computer server 308 provides the network client 216 associated with one of the network users with a network client update, at step S504. The network client update indicates the occurrence of the associated pre-determined event(s). The network client 216 is configured to notify the associated network user of the occurrence of the pre-determined event(s) that were indicated at step S504.

### 5. Real-Time Data Processing—Detailed Discussion

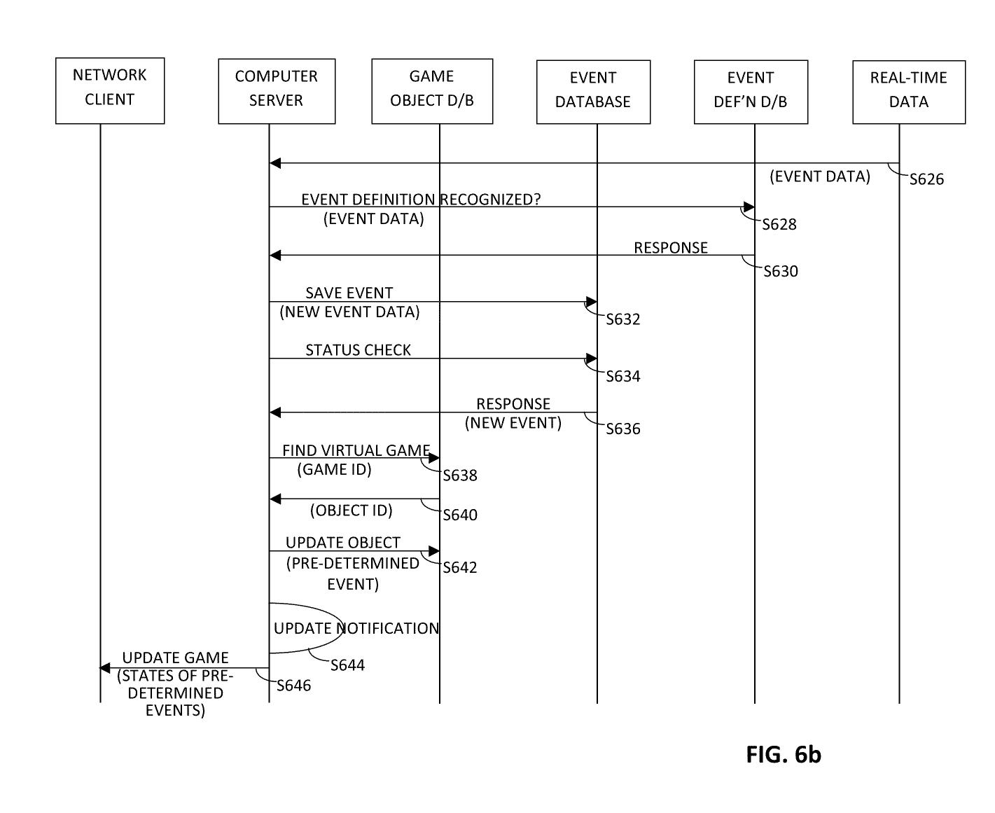

A preferred implementation of the method of updating the network clients 216 will now be discussed with reference to FIGS. 6a and 6b. In this implementation, the real-time data source 400 provides the event data processing system 300 with streaming event data associated with a plurality of live baseball games, and the event data processing system 300 uses the received streaming event data to host a plurality of online baseball-themed virtual bingo games. Again, as discussed above, the invention described herein is not limited to this particular implementation, but can be implemented using event data associated with other sports games or with non-sports activities.

The computer server 308 maintains in the game object database 306 a plurality of data objects. A number of the data objects are associated with a common virtual bingo game. Typically, each virtual bingo game is defined by a parent data object, and a plurality of child data objects associated with the parent data object. Each parent data object is associated with one of the baseball games. Each child data object is uniquely associated with one of the network users, and identifies a plurality of pre-determined events. Since the streaming event data may include event data for a plurality of baseball games, in effect the parent data object for each virtual bingo game is associated with a respective portion of the streaming event data (in this case, streaming event data from the corresponding baseball game), and each virtual bingo game is associated with a portion of the streaming event data.

### (i) Baseball Game Selection/Bingo Card Generation

At step S600, the network user of one of the communications devices 200 invokes the network client 216, whereupon the communications device 200 connects to the event data processing system 300 via the network client 216. Preferably, the network client 216 is pre-configured with the network address of the computer server 308 to thereby allow the network client 216 to connect to the computer server 308 without user input.

At step S602, the computer server 308 transmits a message to the network client 216 which causes the network client 216 to display a message on the display device 204 prompting the network user to authenticate to the event data processing system 300. In response, the network user uses the input device 202 of the communications device 200 to input user credentials (e.g. userID/passcode) into the network client 216. The network client 216 transmits the user credentials to the computer server 308, at step S604.

The computer server 308 may maintain a secure database of user credentials, and may authenticate the network user by comparing the network user's credentials, provided at step S604, with the credentials saved in the credential database. Alternately, the computer server 308 may use a third-party authentication server to authenticate the network. For example, if the network user is a registered user of the Facebook® social network service, the network client 216 may use an authentication dialog application installed on the communications device 200 to pass the network user's Facebook® userID/passcode to a Facebook® web server. If authentication of the network user's Facebook® userID/passcode is successful, the network client 216 may receive an access token from the Facebook® web server, and may then pass the access token to the computer server 308 to thereby confirm the authentication of the network user to the computer server 308.

If authentication of the network user is successful, the event processor 316 of the computer server 308 compiles a list of upcoming baseball games from game data (e.g. game ID, start date/time, stadium, team names, player roster) of upcoming baseball games. The event processor 316 may periodically receive the game data from the real-time data source 400 or another sports data source, and may save the game data in the computer-readable medium 314. At step S606, the event processor 316 transmits to the network client 216 a message that identifies the game ID, start date/time, stadium and team names of the upcoming baseball games. In response, the network client 216 displays particulars (e.g. start date/time, stadium, team names) of the upcoming baseball games on the display device 204.

The network user uses the input device 202 to select one of the upcoming baseball games. At step S608, the network client 216 transmits to the computer server 308 the game ID of the selected upcoming baseball game.

As discussed above, the computer server 308 maintains in the game object database 306 at least one parent data object, each associated with one of the upcoming baseball games and a virtual bingo game. Preferably, each parent data object identifies the game ID, start date/time, stadium, and team names of a respective one of the upcoming baseball games. Accordingly, upon receipt of the game ID, at step S610 the computer server 308 determines whether a virtual bingo game has already been associated with the selected upcoming baseball game. To do so, the computer server 308 queries the game object database 306 with the game ID to locate the parent data object associated with the selected upcoming baseball game.

If no parent data object for the selected baseball game is located, the computer server 308 generates a new virtual bingo game by creating a new parent data object in the game object database 306. The computer server 308 associates the new parent data object with the selected upcoming baseball game by updating the parent data object with the game ID, start date/time, stadium, and team names of the selected game.

The computer server 308 also maintains in the game object database 306 a plurality of child data objects, each uniquely associated with one of the parent data objects. Accordingly, after the computer server 308 locates (or generates) a parent data object for the selected upcoming baseball game, at step S612 the computer server 308 may create a new child data object in the game object database 306, and associate the child data object with the parent data object for the selected upcoming baseball game by linking the child data object to the parent data object. Preferably, one of the computer processing units of the game object database 306 assigns a unique game object ID to the child data object when the child data object is created, and returns the game object ID to the computer server 308, at step S614.

To increase the speed with which the child data objects can be updated from the streaming event data, preferably the computer server 308 maintains a maximum limit on the number of child data objects associated with each parent data object. Therefore, even if the computer server 308 locates an existing parent data object for the selected upcoming baseball game, instead of creating a new child data object for the parent data object, the computer server 308 may nevertheless create a new parent data object in the game object database 306 for the same selected baseball game if the located parent data object is already associated with the maximum number of child data objects.

As will be apparent, since each parent data object is uniquely associated with a respective virtual bingo game, each baseball game may become associated with a plurality of virtual bingo games depending upon the number of network users that have selected each particular baseball game and the maximum limit for the number of child data objects. Therefore, preferably the computer server 308 assigns a unique virtual game name to each virtual bingo game to distinguish between the different virtual bingo games for the same selected baseball game.

Each child data object is uniquely associated with a respective network user. Accordingly, when the computer server 308 creates a new child data object, preferably the computer server 308 associates the child data object with the network user by updating the child data object with the userID of the network user. As a consequence, when the network client 216 transmits the game ID of the selected upcoming baseball game to the computer server 308, in effect the network client 216 registers with the computer server 308 a unique association between the network user and one of the data objects maintained by the computer server 308.

Each child data object also identifies a plurality of pre-determined events and includes a state identifier indicating the occurrence state (e.g. occurred/not occurred) of each of the pre-determined events. Each pre-determined event defines an anticipated sports-related event (e.g. home run, strike-out, walk, fly ball) that could occur in the baseball game of the associated parent data object. Accordingly, when the computer server 308 creates a new child data object, the computer server 308 also generates a plurality of pre-determined events and updates the child data object with the pre-determined events and associated state identifiers. At this stage, the computer server 308 assigns the state value “not occurred” to each state identifier.

Typically, each pre-determined event is associated with one of the bingo squares of a virtual bingo card. Accordingly, the computer server 308 may associate each pre-determined event, in the child data object, with an index number that indicates the intended bingo square position of the pre-determined event on the virtual bingo card. The number of pre-determined events generated by the computer server 308 for each virtual bingo game typically is equal to the total number of squares of the associated virtual bingo card. Each pre-determined event may also have an associated virtual point value.

Preferably, the computer server 308 generates the pre-determined events based on the probability of occurrence of the various anticipated sports-related events in the associated baseball game, and assigns the generated pre-determined events to the new child data object. To facilitate this variation, the event data processing system 300 may receive probability data for various sports-related events from the real-time data source 400. Alternately, the computer server 308 may compute the probability data for the various sports-related events, on an on-going basis, based on the streaming event data received from the real-time data source 400.

The computer server 308 uses the unique virtual game name of the virtual bingo game (associated with the upcoming baseball game selected by the network client 216) and the unique game object ID of the network user's child data object to generate a unique streaming address for the network user's virtual bingo game. The computer server 308 then associates the virtual bingo game with the network user by updating the network user's child data object with the streaming address, at step S616. Therefore, in effect the user selects one of the virtual bingo games, and the computer server 308 uniquely associates the network user with a virtual bingo card of the selected virtual bingo game when the network users selects one of the upcoming baseball games at step S608.

At step S618, the computer server 308 transmits to the network client 216 a message that includes the generated streaming address, thereby confirming that the network user has been authorized to participate in the selected virtual bingo game. As will be discussed below, the network client 216 uses the streaming address to receive real-time updates to the network user's virtual bingo card, based on the streaming event data received at the event data processing system 300.

If the network user is a registered user of the Facebook® social network service, the network user may use the network client 216 to issue invitations to friends of the network user via the Facebook® web server. The invitations may include the unique virtual game name that was assigned to the virtual bingo game to thereby invite the network user's friends to participate in the specified virtual bingo game. The network user's friends may receive a notification of their invite on their respective Facebook® account and/or respective network client 216.

After the network client 216 receives the streaming address of the virtual bingo card associated with the selected virtual bingo game, the network client 216 registers to receive updates to the virtual bingo card from the event data processing system 300. To do so, at step S620 the network client 216 opens a communications channel with the publisher/subscriber processor 320, and transmits the streaming address to the publisher/subscriber processor 320 over the communications channel. Thereafter, the publisher/subscriber processor 320 maintains an association between the network user's virtual bingo card and the communications channel while the communications channel remains open.

### (ii) Bingo Card State Update

At any time after the computer server 308 creates a new child data object for the network user, the event monitor 318 may notify the publisher/subscriber processor 320 of the current state of the network user's virtual bingo card. To do so, at step S622 the event monitor 318 may transmit to the publisher/subscriber processor 320 a message that includes the streaming address of the virtual bingo card specified in the new child data object, and the state and associated index number for each of the pre-determined events specified in the new child data object.

The publisher/subscriber processor 320 uses the streaming address to determine the communications channel that was opened by the network client 216 at step S620. The publisher/subscriber processor 320 generates a virtual game initialize message that identifies the state and associated index number for each of the pre-determined events of the new child data object, and pushes the virtual game initialize message to the network client 216 over the communications channel, at step S624. As discussed above, at this step the state identifier for each pre-determined event is assigned the state value “not occurred”.

In response, the network client 216 displays on the display device 204 a virtual bingo card that depicts each of the pre-determined events for the associated virtual bingo game, with each pre-determined event being depicted at the bingo square position specified by the associated index number. Since the state identifier for each pre-determined event is assigned the state value “not occurred”, preferably the network client 216 depicts each virtual bingo square with a colour and/or intensity indicative of this state value.

Thereafter, at step S626 the event data processing system 300 receives from the real-time data source 400 streaming event data associated with the upcoming live sports games. As will be appreciated, the data streams received from the real-time data source 400 for each live sports game begin at the start date/time of the respective sports game and terminate at the end date/time thereof.

Upon receipt of streaming event data specifying an event in one of the live sports games, at step S628 the event processor 316 queries the event definition database 302 to determine whether the specified event corresponds to one of the event definitions. The event processor 316 receives a response from the event definition database 302, at step S630. If no corresponding event definition is found in the event definition database 302, the event processor 316 ignores the event.

If the event processor 316 locates a corresponding event definition in the event definition database 302, at step S632 preferably the event processor 316 saves the particulars (event, time/date of occurrence of event) of the received event in an event record of the event database 304. As such, the event processor 316 updates the event database 304 in real-time, or substantially real-time, with a new event record, in accordance with a correspondence between the event data and an event definition stored in the event definition database 302.

The event monitor 318 continuously monitors the event database 304 (for example, at step S634), and uses the time/date stamp associated with each event data record to locate new event data records. Accordingly, at step S636 the event monitor 318 locates the received event. At step S638, the event monitor 318 determines whether the game ID, specified in the received event, corresponds to the game ID specified in any parent data object saved in the game object database 306. If no corresponding parent data object is found in the game object database 306, the event monitor 318 ignores the event.

If the event monitor 318 locates one or more corresponding parent data objects in the game object database 306, the event monitor 318 determines whether the received event corresponds to a pre-determined event specified in any child data object of the located parent data object(s). If no corresponding child data object is found in the game object database 306, the event monitor 318 ignores the event.

If the event monitor 318 locates one or more corresponding child data objects in the game object database 306 (for example, at step S640), at step S642 the event monitor 318 updates the state identifier of the corresponding pre-determined event of the located child data object(s) to indicate that the pre-determined event has occurred. Accordingly, at steps S636 to S642, the event monitor 318 updates at least one data object in the game object database 306 from the event record(s) saved in the event database 304. At this stage, the state identifier for each of the corresponding pre-determined events is assigned the state value “occurred”.

As discussed above, since each parent data object defines a virtual bingo game, the child data objects of each parent data object are all associated with a common virtual bingo game. Therefore, in effect, at steps S636 to S642 the event monitor 318 uses the event data to identify/locate the corresponding common virtual bingo game, and to update the data objects of the common virtual bingo game in accordance with the pre-determined events that correspond to the event.

The event processor 316 and event monitor 318 continue to perform steps S626 to S642 to thereby update the child data objects in the game object database 306 in real-time, or substantially real-time, in response to the events as they are reported by the real-time data source 400.

After the event monitor 318 updates a child data object, at step S644 the event monitor 318 may notify the publisher/subscriber processor 320 of the updated state of the virtual bingo card associated with the updated child data object by transmitting to the publisher/subscriber processor 320 a message that includes the streaming address of the virtual bingo card specified in the updated child data object, and the current state and associated index number for each of the pre-determined events specified in the updated child data object. Alternately, instead of the message identifying the current state of all the pre-determined events of the child data object, the message might identify only the pre-determined event(s) whose state identifiers have been updated from “not occurred” to “occurred”.

The publisher/subscriber processor 320 uses the streaming address to determine the communications channel that was opened by the network client 216 at step S620. The publisher/subscriber processor 320 generates a virtual game update message that identifies the current state and associated index number for each of the pre-determined events of the updated child data object. Alternately, the virtual game update message might identify only the pre-determined event(s) whose state identifiers have been updated from “not occurred” to “occurred”. In either case, the virtual game update message indicates the occurrence, in the streaming event data, of one or more pre-determined events.

The publisher/subscriber processor 320 pushes the virtual game update message to the network client 216 over the communications channel, at step S646. Since the event processor 316 receives the event data in real-time, or substantially real-time, and the event monitor 318 updates the game object database 306 and notifies the publisher/subscriber processor 320 in real time, or substantially real-time, in effect the publisher/subscriber processor 320 pushes the virtual bingo game update to the network client 216 upon the occurrence of the pre-determined event specified in the child data object of the network user.

In response, the network client 216 notifies the network user of the occurrence of the indicated pre-determined event(s). To so, the network client 216 updates the virtual bingo card, as displayed on the display device 204, to depict the current/updated state of each of the pre-determined events identified in the virtual game update message. For each state identifier that is assigned the state value “occurred”, preferably the network client 216 depicts each associated virtual bingo square with a colour and/or intensity indicative of this state value.

In one variation, the computer server 308 allows network users to re-arrange or swap the location of bingo squares on their respective virtual bingo cards, any time during the virtual bingo game. The computer server 308 may impose a fixed upper limit on the number of times a network user may swap a bingo square. A network user may use the input device 202 to create a swap request that identifies a pair of the network user's bingo squares. The network client 216 may transmit the swap request to the computer server 308. In response, the computer server 308 may update the network user's child data object in accordance with the particulars of the swap request. As will be appreciated, since each bingo square is uniquely associated with one of the pre-determined events of a child data object, in effect the swap request identifies one of the pre-determined events of the data object for swapping with one of the other pre-determined events of the data object.

In another variation, the computer server 308 allows network users who are participating in a common virtual bingo game to block bingo squares on the virtual bingo cards of other network users of the common virtual bingo game. In this variation, a network user may use the input device 202 to create a block request that identifies the other network user and specifies one of the other network user's bingo squares. The identities of the other network users participating in the common virtual game may have been transmitted to the network client 216, together with the virtual game initialize message, at step S624, or subsequently when additional network users joined the common virtual bingo game. The network client 216 may transmit the block request to the computer server 308. In response, the computer server 308 may update the specified pre-defined event of the identified child data object, using the state value “blocked”. Thereafter, the event monitor 318 will not update the specified pre-defined event of the identified child data object to the state value “occurred”, for the duration of the virtual bingo game, even if the corresponding event occurs during the sports game.

Preferably, the event monitor 318 also maintains a set of rules for each virtual bingo game, and is configured to notify the network users of each virtual bingo game if a data object of one of the virtual bingo games satisfies one or more rules of the set of rules for the associated virtual bingo game. For example, one rule may award a virtual win token to a network user if the state identifier for each of the bingo squares in a column, row or diagonal of the virtual bingo card, as defined by the child data object associated with the network user, are all assigned the state value “occurred”. Another rule may award a virtual win token to a network user if the state identifier for each of the bingo squares at the corners of the virtual bingo card, as defined by the child data object associated with the network user, are all assigned the state value “occurred”.

Accordingly, after the event monitor 318 updates a child data object, the event monitor 318 may also notify the publisher/subscriber processor 320 if any of the data objects of one of the virtual bingo games satisfy one of the rules of the set of rules for the virtual bingo game. To do so, the event monitor 318 may generate a game status message that includes the streaming address of the child data object that satisfies a rule of a virtual bingo game, and also identifies the streaming addresses of all the other child data objects of the virtual bingo game. The event monitor 318 may also increment, in the child data object that satisfies the rule, a data value that specifies the number of virtual win tokens awarded to the network user.

As discussed, each pre-determined event may also have an associated virtual point value. Accordingly, when the event monitor 318 determines that a data object of one of the virtual bingo games satisfies one or more rules of the set of rules for the associated virtual bingo game, the event monitor 318 may use the applicable rule to calculate a win value from the virtual point value associated with each bingo square having the state value “occurred”, and then update the data object with the win value. For example, a rule may award a virtual win token to a network user if the state identifier for each of the bingo squares in a column (or row) of the virtual bingo card are assigned the state value “occurred”. In this situation, if all the bingo squares in a column (or row) of a network user's virtual bingo card are assigned the state value “occurred”, the event monitor 318 may calculate the win value by summing the virtual point values, associated with each bingo square in the column (or row) of the network user's virtual bingo card. The event monitor 318 may include the calculated win value in the game status message.

The event monitor 318 may then transmit the game status message to the publisher/subscriber processor 320, at step S644. The publisher/subscriber processor 320 may use the streaming addresses, included in the game status message, to determine the communications channels over which to communicate the game status message to the network clients 216. The publisher/subscriber processor 320 may push the game status message to the network clients 216 over the respective communications channels, at step S646.

In response, the network clients 216 may notify the respective network users associated with the data objects of the common virtual game that one of the data objects of the common virtual game has satisfied a rule of the set of rules for the virtual bingo game. To do so, each network client 216 identified in the game status message may update the respective display devices 204 to identify the network user whose child data object satisfied the rule of the common virtual bingo game.

1. A method of updating network clients with event data, the method comprising:
a computer server updating an event database with at least one event record in accordance with a correspondence between at least one event definition and event data received at the computer server, each said event record identifying an occurrence of an event in the event data;
the computer server updating at least one data object from the at least one event record, each said data object being uniquely associated with a respective network user and identifying a plurality of pre-determined events, the data object updating identifying an occurrence of at least one of the pre-determined events; and
in accordance with the data object updating, the computer server providing a network client associated with one of the network users a network client update indicating the occurrence of the associated at least one pre-determined events, the network client being configured to notify the associated one network user of the occurrence of the indicated at least one pre-determined event.

2. The method of updating network clients according to claim 1, further comprising the computer server generating the pre-determined events from a probability of occurrence thereof, and assigning the generated pre-determined events to one of the data objects.

3. The method of updating network clients according to claim 1, wherein the computer server associates a virtual game with a portion of the event data, and the updating at least one data object comprises the one network user selecting one of the virtual games, and the computer server associating the data object of the one network user with the selected virtual game.

4. The method of updating network clients according to claim 1, wherein the providing the network client update comprises the network client using the computer server to register an association between the network client and the data object of the one network user, and the computer server pushing the network client update to the registered network client upon the occurrence of the indicated at least one pre-determined event.

5. The method of updating network clients according to claim 1, wherein the computer server uniquely associates each pre-determined event with a respective game tile of a virtual game card, and the updating at least one data object comprises the computer server receiving a swap request from the network client, and updating the data object in accordance with the swap request, the swap request identifying one of the game tiles for swapping with one of the game tiles of the virtual game card.

6. The method of updating network clients according to claim 1, wherein the computer server associates a plurality of the data objects with a common virtual game, and the providing the network client update comprises the computer server maintaining a set of rules, and notifying the network users associated with the data objects of the common virtual game of one of the data objects of the common virtual game satisfying one of the rules of the set of rules.

7. An event data processing system for updating network clients with event data, comprising:
an event definition database comprising a plurality of event definitions;
an event database comprising a plurality of event records; and
a computer server configured to:
(i) receive event data;
(ii) incorporate into the event database a new event record in accordance with a correspondence between one of the event definitions and the received event data, the new event record identifying an occurrence of an event in the event data;
(iii) update at least one data object from the new event record, each said data object being uniquely associated with a respective network user and identifying a plurality of pre-determined events, each said updated data object identifying an occurrence of at least one of the pre-determined events; and
(iv) in accordance with the data object update, provide a network client associated with one of the network users a network client update indicating the occurrence of the associated at least one pre-determined events.

8. The event data processing system according to claim 7, wherein the computer server is further configured to generate the pre-determined events from a probability of occurrence thereof and to assign the generated pre-determined events to one of the data objects.

9. The event data processing system according to claim 7, wherein the computer server associates a virtual game with a portion of the event data, and is configured to receive from the one network user a selection of one of the virtual games and to associate the data object of the one network user with the selected virtual game.

10. The event data processing system according to claim 7, wherein the computer server is configured to provide the network client update by registering an association between the network client and the data object of the one network user in response to a registration request received from the network client, and to push the network client update to the registered network client upon the occurrence of the indicated at least one pre-determined event.

11. The event data processing system according to claim 7, wherein the computer server associates each pre-determined event with a respective game tile of a virtual game card, and is configured to update the at least one data object by receiving a swap request from the network client, and updating the data objects in accordance with the swap request, the swap request identifying one of the game tiles for swapping with one of the game tiles of the virtual game card.

12. The event data processing system according to claim 7, wherein the computer server maintains a set of rules and associates a plurality of the data objects with a common virtual game, and is configured to provide the network client update by notifying the network users associated with the data objects of the common virtual game of one of the data objects of the common virtual game satisfying one of the rules of the set of rules.

13. A method of updating a network client with event data, the method comprising:
a network client registering with a computer server a unique association between a network user and a data object maintained by the computer server, the data object identifying a plurality of pre-determined events, the computer server being configured to receive event data and to update the data object in accordance with an occurrence of one of the associated pre-determined events in the received event data;
the network client receiving from the computer server a network client update indicating the occurrence of the one pre-determined event in the received event data; and
the network client notifying the network user of the occurrence of the indicated one pre-determined event.

14. The method of updating a network client according to claim 13, wherein the computer server is configured to generate the pre-determined events from a probability of occurrence thereof, and to assign the generated pre-determined events to the data object.

15. The method of updating a network client according to claim 13, wherein the computer server associates a virtual game with a portion of the event data, and the network client registering comprises the network client selecting one of the virtual games.

16. The method of updating a network client according to claim 13, wherein the network client receives the network client update from the computer server upon the occurrence of the indicated one pre-determined event.

17. The method of updating a network client according to claim 13, wherein the computer server is configured to update an event database with at least one event record in accordance with a correspondence between at least one event definition and the received event data, each said event record identifying an occurrence of an event in the event data, and the computer server is further configured to update the data object from the at least one event record in accordance with the associated pre-determined events.

18. The method of updating a network client according to claim 13, wherein the computer server is configured to maintain a set of rules and to associate a plurality of the data objects with a common virtual game, each said data object being uniquely associated with a respective network user, and the network client update notifies the network client of one of the data objects of the common virtual game satisfying one of the rules of the set of rules.

19. A communications device comprising:
a display device; and
a data processor configured to:
(i) register with a computer server a unique association between a network user and a data object maintained by the computer server, the data object identifying a plurality of pre-determined events, the computer server being configured to receive event data and to update the data object in accordance with an occurrence of one of the associated pre-determined events in the received event data;
(ii) receive from the computer server a network client update indicating the occurrence of the one pre-determined event in the received event data; and
(iii) display on the display device a notification of the occurrence of the indicated one pre-determined event.

20. The communications device according to claim 19, wherein the computer server is configured to generate the pre-determined events from a probability of occurrence thereof, and to assign the generated pre-determined events to the data object.

21. A computer-readable medium comprising computer processing instructions stored thereon for execution by a computer, the computer processing instructions, when executed by the computer, causing the computer to perform the method of claim 1.
